(19) United States
(12) Patent Application Publication
(10) Pub. No.: US 2026/0006330 A1
(43) Pub. Date: Jan. 1, 2026

(54) APPARATUS AND METHOD FOR CAPTURING IMAGE

(71) Applicant: HANWHA VISION CO., LTD., Seongnam-si (KR)

(72) Inventors: Dae Bong KIM, Seongnam-si (KR); Dong Jin PARK, Seongnam-si (KR); Young Sang KWON, Seongnaim-si (KR)

(73) Assignee: HANWHA VISION CO., LTD., Seongnam-si (KR)

(21) Appl. No.: 19/316,428

(22) Filed: Sep. 2, 2025

Related U.S. Application Data
(63) Continuation of application No. PCT/KR2024/003000, filed on Mar. 8, 2024.

(30) Foreign Application Priority Data
Mar. 9, 2023 (KR) 10-2023-0031174

(51) Int. Cl. H04N 23/67; H04N 23/62; H04N 23/69

(52) U.S. Cl. CPC H04N 23/675; H04N 23/62; H04N 23/69

(57) ABSTRACT

An apparatus for capturing an image includes: a camera including a first lens and configured to generate an image of a subject; a distance determiner configured to determine a distance to the subject; a first focal position calculator configured to calculate a first focal position of the first lens based on the distance to the subject; a second focal position calculator configured to calculate a second focal position of the first lens by analyzing a frequency of an image generated according to adjustment of a position of the first lens; and a controller configured to adjust the position of the first lens based on the first and second focal positions.

### CROSS-REFERENCE TO RELATED APPLICATION(S)

This application is a continuation of International Application No. PCT/KR2024/003000, filed on Mar. 8, 2024, in the Korean Intellectual Property Receiving Office, which is based on and claims priority to Korean Patent Application No. 10-2023-0031174, filed on Mar. 9, 2023, in the Korean Intellectual Property Office, the disclosures of which are incorporated by reference herein in their entireties.

### BACKGROUND

### 1. Field

The disclosure relates to an apparatus and method for capturing an image, and more particularly, to an apparatus and method for capturing an image that performs focusing based on distance information and image analysis information.

### 2. Description of Related Art

A camera equipped with a focus lens performs focusing on a subject by adjusting the position of the focus lens. The focusing may be performed by a user or may be automatically performed by the camera.

To perform auto focusing, the camera may refer to the distance to the subject. The camera performs focusing by adjusting the position of the focus lens based on the distance to the subject. The camera may include association data that represents a correlation between the distance to the subject and the position of the focus lens. However, since the association data does not reflect information on the installation environment of the camera, focusing using the association data may not provide accurate results.

Accordingly, there is a demand for an invention that provides optimal focusing results when focusing is performed by the camera.

### SUMMARY

The disclosure relates to providing an apparatus and method for capturing an image that performs focusing based on distance information and image analysis information.

The disclosure is not limited to the aspects described above, and additional aspect will be understood from the following description.

According to an aspect of the disclosure, an apparatus include: a camera including a first lens and configured to generate an image of a subject; a distance determiner configured to determine a distance to the subject; a first focal position calculator configured to calculate a first focal position of the first lens based on the distance to the subject; a second focal position calculator configured to calculate a second focal position of the first lens by analyzing a frequency of an image generated according to adjustment of a position of the first lens; and a controller configured to adjust the position of the first lens based on the first and second focal positions.

The first focal position calculator may be configured to calculate the first focal position based on a focal position table including correlations among the distance to the subject, a zoom level, an installation environment of the camera, and a focal position of the first lens.

The controller may be configured to update the focal position of the first lens included in the focal position table based on a difference between the first and second focal positions.

The installation environment of the camera may include an ambient temperature of the camera and an installation posture of the camera.

The controller may be configured to adjust the position of the first lens according to the first focal position and then adjusts the position of the first lens to calculate the second focal position.

According to another aspect of the disclosure, an apparatus for capturing an image may include: a camera including a first lens and a second lens and configured to generate an image of a subject; an input interface configured to receive a target point selection command for selecting a target point in the image; a first focal position calculator configured to calculate a first focal position of the first lens to improve sharpness of an image of a subject region formed based on the target point; and a controller configured to control the second lens such that the subject region may be enlarged at a selected zoom level and to adjust a position of the first lens according to the first focal position, wherein the first focal position calculator may be configured to calculate a first focal position having a highest priority from among a plurality of first focal positions calculable for the subject region.

The plurality of first focal positions calculable for the subject region may include: a user-set focal position set by a user for the subject region; a distance-based focal position calculated based on a distance to a subject included in the subject region; and a scan-based focal position set through scanning of the subject region.

Priorities of the plurality of first focal positions may be set in an order of the user-set focal position, the distance-based focal position, and the scan-based focal position.

The apparatus may further include a second focal position calculator configured to calculate a second focal position of the first lens by analyzing a frequency of an image generated according to adjustment of the position of the first lens.

According to another aspect of the disclosure, an apparatus for capturing an image may include: a camera including a first lens and a second lens and configured to generate an image of a subject; an input interface configured to receive a region setting command for setting a target region in the image; a first focal position calculator configured to calculate a first focal position of the first lens to improve sharpness of an image of the target region; and a controller configured to control the second lens such that the target region may be enlarged and to adjust a position of the first lens according to the first focal position, wherein the first focal position calculator may be configured to calculate a first focal position having a highest priority from among a plurality of first focal positions calculable for the target region.

The plurality of first focal positions calculable for the target region may include: a user-set focal position set by a user for the target region; a distance-based focal position calculated based on a distance to a subject included in the target region; and a scan-based focal position set through scanning of the target region.

Priorities of the plurality of first focal positions may be set in an order of the user-set focal position, the distance-based focal position, and the scan-based focal position.

The apparatus may further include a second focal position calculator configured to calculate a second focal position of the first lens by analyzing a frequency of an image generated according to adjustment of the position of the first lens.

According to another aspect of the disclosure, a method for capturing an image by an apparatus for capturing an image that includes a first lens, may include: generating an image of a subject; determining a distance to the subject; calculating a first focal position of the first lens based on the distance to the subject; adjusting a position of the first lens according to the first focal position; calculating a second focal position of the first lens by analyzing an image generated according to adjustment of the position of the first lens; and adjusting the position of the first lens according to the second focal position.

The calculating of the first focal position may include calculating the first focal position based on a focal position table including correlations among the distance to the subject, a zoom level, an installation environment of the camera, and a focal position of the first lens.

The method may further include updating a focal position of the first lens included in the focal position table based on a difference between the first and second focal positions.

According to another aspect of the disclosure, a method for capturing an image, may include: generating an image of a subject; receiving a target point selection command for selecting a target point in the image; controlling a second lens such that a subject region formed based on the target point may be enlarged at a selected zoom level; calculating a first focal position of a first lens to improve sharpness of the subject region; and adjusting a position of the first lens according to the first focal position, wherein the calculating of the first focal position comprises calculating a first focal position having a highest priority from among a plurality of first focal positions calculable for the subject region.

The plurality of first focal positions calculable for the subject region may include: a user-set focal position set by a user for the subject region; a distance-based focal position calculated based on a distance to a subject included in the subject region; and a scan-based focal position set through scanning of the subject region, and priorities of the plurality of first focal positions may be set in an order of the user-set focal position, the distance-based focal position, and the scan-based focal position.

According to another aspect of the disclosure, a method for capturing an image, may include: generating an image of a subject; receiving a region setting command for setting a target region in the image; controlling a second lens such that the target region may be enlarged to a size of a screen region; calculating a first focal position of the first lens to improve sharpness of the image of the target region; and adjusting a position of a first lens according to the first focal position, wherein the calculating of the first focal position comprises calculating a first focal position having a highest priority from among a plurality of first focal positions calculable for the target region.

The plurality of first focal positions calculable for the target region may include: a user-set focal position set by a user for the target region; a distance-based focal position calculated based on a distance to a subject included in the target region; and a scan-based focal position set through scanning of the target region, and priorities of the plurality of first focal positions may be set in an order of the user-set focal position, the distance-based focal position, and the scan-based focal position.

Specific details of other embodiments are included in the detailed description and the drawings.

According to the aforementioned apparatus and method of the disclosure, since focusing is performed by comprehensively referring to distance information and image analysis information, there is an advantage in that the results of the focusing may be improved.

The effects of the disclosure are not limited to those mentioned above, and other effects not mentioned will be clearly understood by those skilled in the art from the description of the claims.

### BRIEF DESCRIPTION OF DRAWINGS

FIG. 1 is a block diagram of an apparatus for capturing an image according to an embodiment of the disclosure.

FIG. 2 is a diagram illustrating a camera illustrated in FIG. 1.

FIG. 3 is a diagram for explaining enlargement of a target point.

FIG. 4 is a diagram for explaining enlargement of a target region.

FIG. 5 is a diagram for explaining enlargement of a user-designated region.

FIG. 6 is a diagram for explaining first focal positions.

FIG. 7 is a diagram for explaining scanning of a surveillance region.

FIG. 8 is a diagram for explaining the priorities of the first focal positions.

FIG. 9 is a diagram illustrating a detailed configuration of a second focal position calculator illustrated in FIG. 1.

FIG. 10 is a diagram for explaining the functions of a first focal position calculator.

FIG. 11 illustrates a focal position table.

FIG. 12 is a diagram for explaining adjustment of a focus lens position according to the first focal positions.

FIG. 13 is a diagram for explaining adjustment of the focus lens position according to the second focal position.

FIG. 14 is a diagram for explaining adjustment of the focus lens position according to updated first focal positions.

FIG. 15 is a flowchart illustrating a method for capturing an image according to an embodiment of the disclosure.

### DETAILED DESCRIPTION

Embodiments of the disclosure will hereinafter be described in detail with reference to the accompanying drawings. The advantages and features of the disclosure, and methods for achieving them, will be clearly understood with reference to the embodiments described below in detail together with the accompanying drawings. However, the disclosure is not limited to the embodiments set forth below and may be implemented in various other forms. These embodiments are provided merely to ensure the completeness of the disclosure and to fully convey the scope of the disclosure to those skilled in the art, and the disclosure is defined only by the scope of the claims. Throughout this specification, the same reference numerals denote the same components.

Unless otherwise defined, all terms (including technical and scientific terms) used in this specification may be interpreted as having meanings commonly understood to which the disclosure pertains. Terms defined in generally used dictionaries are not to be interpreted in an idealized or excessively broad sense unless clearly and specifically defined otherwise.

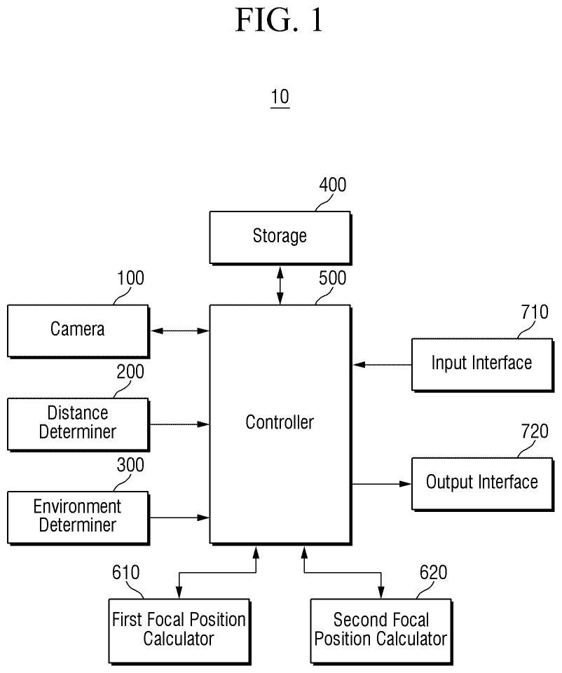

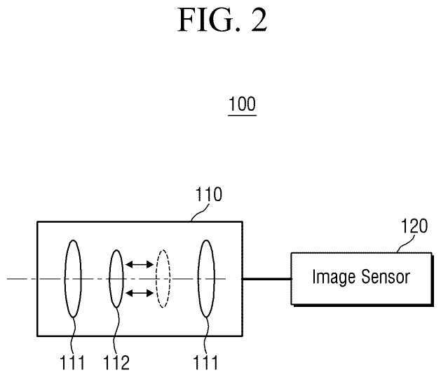

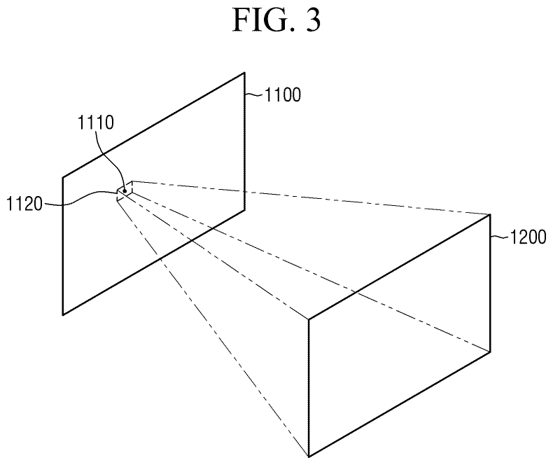

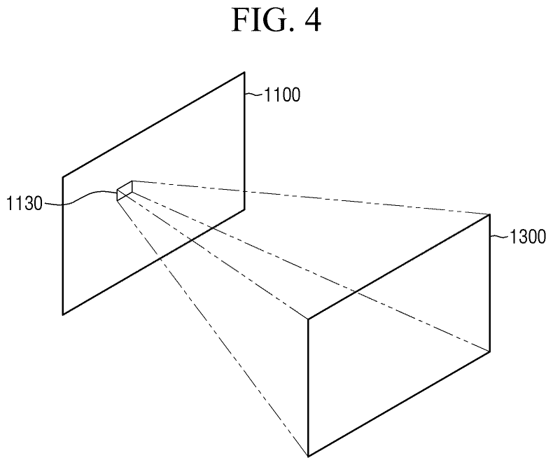

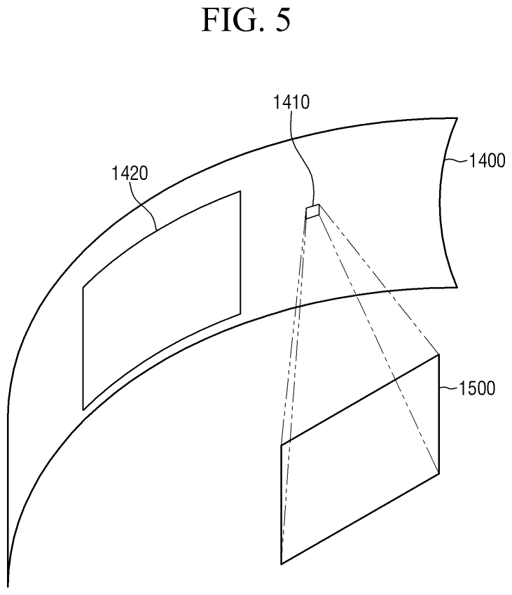

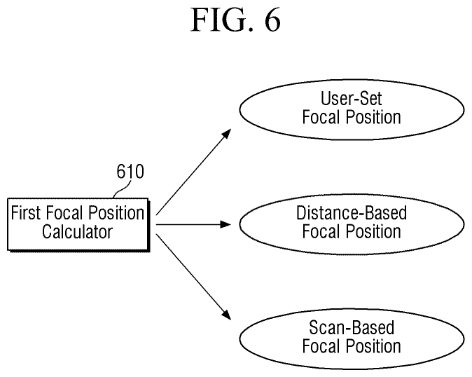

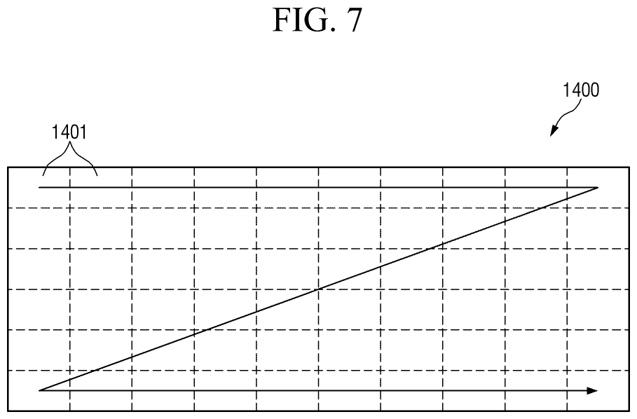

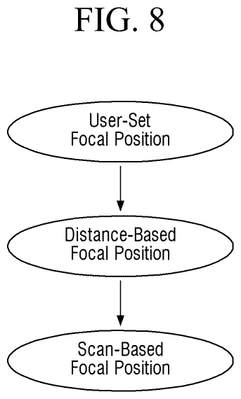

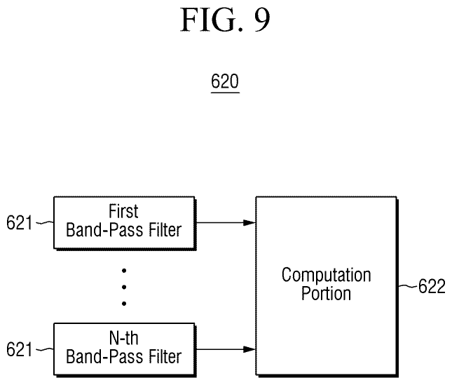

FIG. 1 is a block diagram of an apparatus for capturing an image according to an embodiment of the disclosure, FIG. 2 is a diagram illustrating a camera illustrated in FIG. 1, FIG. 3 is a diagram for explaining enlargement of a target point, FIG. 4 is a diagram for explaining enlargement of a target region, FIG. 5 is a diagram for explaining enlargement of a user-designated region, FIG. 6 is a diagram for explaining first focal positions, FIG. 7 is a diagram for explaining scanning of a surveillance region, FIG. 8 is a diagram for explaining the priorities of the first focal positions, and FIG. 9 is a diagram illustrating a detailed configuration of a second focal position calculator illustrated in FIG. 1.

Referring to FIG. 1, an apparatus 10 for capturing an image according to an embodiment of the disclosure may include a camera 100, a distance determiner 200, an environment determiner 300, a storage 400, a controller 500, a first focal position calculator 610, a second focal position calculator 620, an input interface 710, and an output interface 720.

The camera 100 may generate an image of a subject. As illustrated in FIG. 2, the camera 100 may include a lens portion 110 and an image sensor 120. The image generated by the camera 100 in the disclosure may be a moving image or a still image.

The lens portion 110 may receive light from the subject and background. The lens portion 110 may include a plurality of lenses (111 and 112). The lenses (111 and 112) may be arranged side by side along the optical axis of the lens portion 110 and may sequentially transmit light therethrough. The lens portion 110 may include various lenses (111 and 112) for focusing light, enhancing the boundary of the subject, enhancing the color of the subject, or reducing distortion of the shape of the subject. The lens portion 110 may include a zoom lens. The zoom lens may enlarge or reduce an image of the subject. The lens portion 110 may include a focus lens 112. The focus lens 112 may move in a direction parallel to the optical axis of the lens portion 110. The focal position relative to the subject may change according to the position of the focus lens 112.

In the disclosure, enlargement of an image by the zoom lens may include enlargement of a target point, enlargement of a target region, and enlargement of a user-designated region.

Referring to FIG. 3, target point enlargement may be performed by selecting a target point 1110 from an image 1100 from the camera 100.

The target point 1110 may be selected by receiving a target point selection command from a user. The zoom lens may enlarge a subject region 1120 formed based on the target point 1110 at a selected zoom level. For example, the zoom lens may enlarge the subject region 1120 by 30 times, and the output interface 720 may output an image 1200 of the subject region 1120.

Referring to FIG. 4, target region enlargement may be performed by setting a target region 1130 in the image 1100 from the camera 100.

The target region 1130 may be set by receiving a region setting command from the user. For example, the user may set the target region 1130 by forming a rectangular box in the image 1100 from the camera 100.

The zoom lens may enlarge the target region 1130. For example, the zoom lens may enlarge the target region 1130 to the size of a selected screen region, and the output interface 720 may output an image 1300 of the target region 1130.

Referring to FIG. 5, user-designated region enlargement may be performed by selecting a user-designated region 1410, which is set by the user, from a surveillance region 1400 captured by the camera 100.

In the disclosure, the camera 100 may be capable of posture adjustment. For example, the camera 100 may include a posture adjustment means having pan and tilt functions for changing the shooting direction of the camera 100. The surveillance region 1400 represents a region to be captured through posture adjustment of the camera 100.

The user-designated region 1410 may be selected by receiving a user-designated region selection command from the user. For example, the user may select the user-designated region 1410 from among a plurality of selected user-designated regions. The user-designated region 1410 may be included in or located outside a region 1420, which is output through the output interface 720, within the surveillance region 1400.

The zoom lens may enlarge the user-designated region 1410 to a selected zoom level. Here, the zoom level may be set by the user. The zoom lens may enlarge the user-designated region 1410 to the corresponding zoom level, and the output interface 720 may output an image 1500 of the user-designated region 1410.

Referring again to FIG. 2, the image sensor 120 may generate an image using light incident through the lens portion 110. For example, a charge-coupled device (CCD) or a complementary metal-oxide semiconductor (CMOS) device may serve as the image sensor 120.

Referring again to FIG. 1, the distance determiner 200 may determine the distance to a subject. The distance determiner 200 may determine the distance to the subject using laser, ultrasonic waves, or infrared rays. The distance determiner 200 may emit laser, ultrasonic waves, or infrared rays in a direction parallel to the optical axis of the camera 100 and determine the distance to the subject using a reflected signal from the subject. In another example, the distance determiner 200 may determine the distance to the subject by analyzing an image using an artificial intelligence (AI) model. For example, the distance determiner 200 may generate a depth map for the image 1100 from the camera 100 and determine the distance to the subject through AI analysis of the depth map. In another example, the distance determiner 200 may determine the distance to the subject through AI analysis of objects included in the image 1100 from the camera 100.

The environment determiner 300 may determine the installation environment of the camera 100. The installation environment of the camera 100 may include the surrounding temperature of the camera 100 and the installation posture of the camera 100. To determine the surrounding temperature of the camera 100, the environment determiner 300 may include a temperature sensor. For example, to determine the installation posture of the camera 100, the environment determiner 300 may include an acceleration sensor.

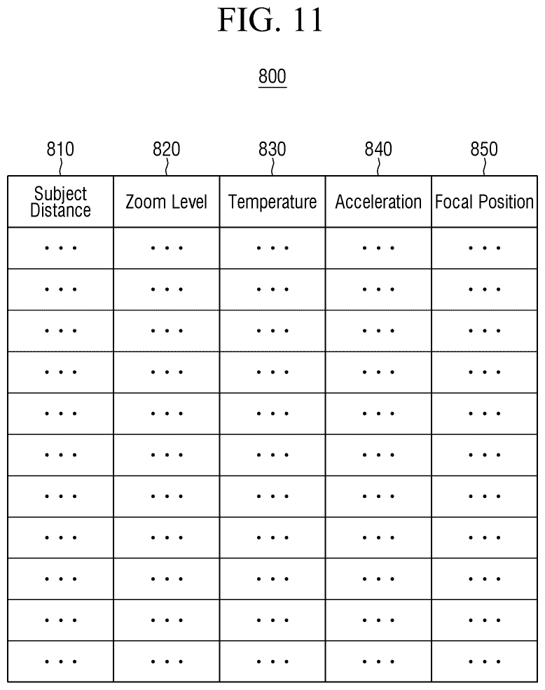

The storage 400 may temporarily or permanently store images generated by the camera 100. The storage 400 may also store a focal position table 800, which will be described later (see FIG. 11). For example, the storage 400 may store a user-set focal position and a scan-based focal position, both of which will be described later.

Referring to FIGS. 1 and 6, the first focal position calculator 610 may calculate first focal positions.

First focal positions calculable by the first focal position calculator 610 may include a user-set focal position, a distance-based focal position, and a scan-based focal position.

The user-set focal position may be set by the user with respect to the subject region 1120 or the target region 1130. For example, the user may set a focal position for a specific point or a specific region in the surveillance region 1400. Specifically, the user may adjust the shooting direction and zoom level of the camera 100 using the posture adjustment means and the zoom lens, and then set a focal position for the specific point or specific region. The user-set focal position represents a first focal position set in this manner. The user-set focal position may be stored in the storage 400.

The distance-based focal position may be calculated based on the distance to the subject. The first focal position calculator 610 may calculate a first focal position of the focus lens 112 based on the subject distance determined by the distance determiner 200. The focal position table 800 may include relationships between subject distances and focal positions. The first focal position calculator 610 may extract a first focal position corresponding to the determined subject distance from the focal position table 800.

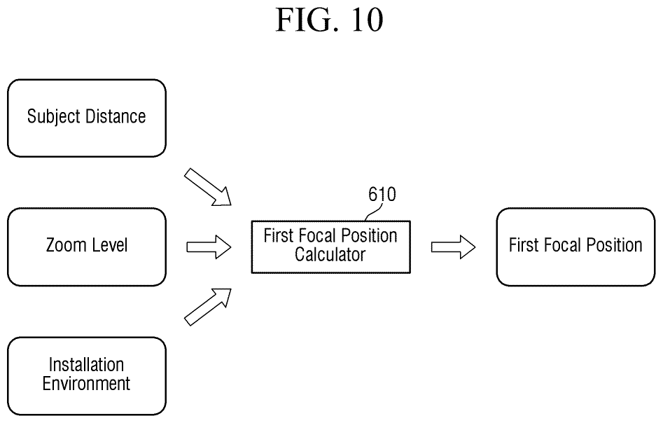

In calculating the distance-based focal position, the first focal position calculator 610 may refer not only to the determined subject distance but also to the installation environment of the camera 100, as determined by the environment determiner 300. This will be described later in further detail with reference to FIG. 10.

The scan-based focal position may be calculated through scanning of the surveillance region 1400.

Referring to FIG. 7, by scanning the surveillance region 1400, which includes a plurality of divided regions 1401, the controller 500 may set a focal position for each of the divided regions 1401.

The controller 500 may perform scanning of the surveillance region 1400 in response to a user command or automatically. Under the control of the controller 500, the camera 100 may scan the surveillance region 1400 in units of the divided regions 1401, and the first focal position calculator 610 may calculate a focal position for each of the divided regions 1401. For example, the first focal position calculator 610 may calculate a focal position that most improves the sharpness of the image of each of the divided regions 1401 while adjusting the focus lens 112, and determine the calculated focal position as the first focal position of the corresponding divided region 1401. The scan-based focal position may be stored in the storage 400.

Referring again to FIG. 1, when a target point selection command is input through the input interface 710, the first focal position calculator 610 may calculate a first focal position of the focus lens 112 for improving the sharpness of an image 1200 of the subject region 1120 formed based on the target point 1110. When the calculation of the first focal position is completed, the controller 500 may control the zoom lens so that the subject region 1120 may be enlarged at a selected zoom level, and adjust the position of the focus lens 112 according to the calculated first focal position.

In another example, when a region setting command is input through the input interface 710, the first focal position calculator 610 may calculate a first focal position of the focus lens 112 for improving the sharpness of an image of the target region 1130. When the calculation of the first focal position is completed, the controller 500 may control the zoom lens so that the target region 1130 may be enlarged, and adjust the position of the focus lens according to the calculated first focal position.

A plurality of first focal positions may be calculable by the first focal position calculator 610. For example, the first focal positions calculable by the first focal position calculator 610 may include the user-set focal position, the distance-based focal position, and the scan-based focal position.

The first focal position calculator 610 may calculate a first focal position having the highest priority among a plurality of first focal positions calculable for the subject region 1120 or among a plurality of first focal positions calculable for the target region 1130.

Referring to FIG. 8, the priorities of the plurality of first focal positions calculable by the first focal position calculator 610 may be set in the order of the user-set focal position, the distance-based focal position, and the scan-based focal position.

The user-set focal position may be a first focal position directly set by the user. The distance-based focal position may be a first focal position calculated at the current time of generation of a current image by the camera 100. The scan-based focal position may be a first focal position calculated at a previous time prior to the generation of the current image by the camera 100. A focal position calculated at a previous time may have a higher likelihood of reflecting error compared to a focal position calculated at the current time. Therefore, the priority of the distance-based focal position may be set higher than that of the scan-based focal position. Furthermore, since the user-set focal position is directly set by the user, the priority of the user-set focal position may be set higher than that of the distance-based focal position.

The user-set focal position and the scan-based focal position may be calculated in advance and stored in the storage 400, and thus their numbers may be limited. For example, the user-set focal position and the scan-based focal position may not necessarily be set for the subject region 1120 or the target region 1130 selected by the user.

Accordingly, when the subject region 1120 or the target region 1130 is determined, the first focal position calculator 610 may determine whether the user-set focal position or the scan-based focal position is set for the corresponding region. When at least one of the user-set focal position or the scan-based focal position is set for the subject region 1120 or the target region 1130, a first focal position for the subject region 1120 or the target region 1130 may be calculated based on the set focal position. For example, when the user-set focal position is set for the subject region 1120 or the target region 1130, the first focal position calculator 610 may calculate the user-set focal position as the first focal position of the subject region 1120 or the target region 1130. When the user-set focal position is not set but the scan-based focal position is set, the first focal position calculator 610 may calculate the distance-based focal position as the first focal position of the subject region 1120 or the target region 1130.

The second focal position calculator 620 may calculate a second focal position of the focus lens 112 by analyzing the frequency of an image generated as the position of the focus lens 112 is adjusted. The sharpness of the image may change as the position of the focus lens 112 is adjusted. The second focal position calculator 620 may calculate the position of the focus lens 112 at which the sharpness of the image is highest as the second focal position of the focus lens 112.

Referring to FIG. 9, the second focal position calculator 620 may include band-pass filters 621 and a computation portion 622.

A plurality of band-pass filters 621 may be provided. Each of the band-pass filters 621 may be configured to filter an input image in the frequency domain. The band-pass filters 621 may have different filter characteristics as needed, and the number of band-pass filters 621 may vary. The pass bandwidth of each of the band-pass filters 621 may be appropriately adjusted as needed to, for example, −3 dB.

The computation portion 622 may calculate the output of each of the band-pass filters 621 to provide a second focal position. The output of the band-pass filters 621 may be computed in various manners. For example, the second focal position may include the sum of the outputs of the band-pass filters 621. Further, the second focal position may include peak data of the outputs of the band-pass filters 621.

When an image obtained at a specific focus position of the focus lens 112 is passed through all of the band-pass filters 621 and the outputs of the band-pass filters 621 are computed to calculate focus values, the apparatus 10 may consume a relatively large amount of resources to perform such operations or calculations. In another example, according to the resources included in the apparatus 10, the time required to complete such operations or calculations may be relatively long.

According to an embodiment of the disclosure, the second focal position calculator 620 may pass the input image through a selected band-pass filter 621 among the band-pass filters 621, and the computation portion 622 may perform a calculation on the output of the selected band-pass filter 621 to provide a focal position. For example, the second focal position calculator 620 may select a band-pass filter 621 corresponding to the current focal position of the focus lens 112 from among the band-pass filters 621, and pass the input image through the selected band-pass filter 621. The current focal position of the focus lens 112 may be received from the controller 500.

The band-pass filters 621 corresponding to the respective focal positions may be used to output a focal position, and a plurality of focal positions output in this manner may be used to find an in-focus position (IFP), i.e., a second focal position.

The input interface 710 may receive a user command. The user command may include a target point selection command, a region setting command, and a user-designated region selection command described above. Specifically, the input interface 710 may receive a target point selection command for selecting the target point 1110 in the image 1100 from the camera 100, a region setting command for setting the target region 1130 in the image 1100 from the camera 100, or a user-designated region selection command for selecting the user-designated region 1410 in the surveillance region 1400.

For example, the input interface 710 may receive a surveillance region scan command for calculating a scan-based focal position. The input interface 710 may include any one or any combination of a socket, a plug, a cable, a universal serial bus (USB), a keyboard, a mouse, a microphone, a scanner, a digital modem, a radio frequency (RF) modem, an antenna circuit, a WiFi chip, and their equivalents along with related software and/or firmware.

The output interface 720 may output an image generated with focus adjusted according to the first and second focal positions. For example, the output interface 720 may visually display the focus-adjusted image. In some embodiments of the disclosure, the output interface 720 may include a communication function and transmit the focus-adjusted image. The user may receive and check the image transmitted by the output interface 720 on their own terminal. The output interface 720 may include any one or any combination of a plug, a cable, a speaker, a display device such as a liquid crystal display (LCD), an organic light emitting diode (OLED) display, a micro light emitting diode (LED) display, not being limited thereto, a digital modem, an RF modem, an antenna circuit, a WiFi chip, and their equivalents along with related software and/or firmware.

The controller 500 may perform overall control of the camera 100, the distance determiner 200, the environment determiner 300, the storage 400, the first focal position calculator 610, the second focal position calculator 620, the input interface 710, and the output interface 720. The controller 500 may control the zoom lens so that the subject region 1120 may be enlarged at a selected zoom level or the target region 1130 may be enlarged. The controller 500 may also adjust the position of the focus lens 112 according to first and second focal positions. When the first focal position is calculated by the first focal position calculator 610, the controller 500 may adjust the position of the focus lens 112 according to the calculated first focal position.

Additionally, to calculate the second focal position by the second focal position calculator 620, the controller 500 may adjust the position of the focus lens 112. To calculate the second focal position, the position of the focus lens 112 needs to be continuously adjusted, and the controller 500 adjusts the position of the focus lens 112 for calculation of the second focal position.

After adjusting the position of the focus lens 112 according to the first focal position, the controller 500 may adjust the position of the focus lens 112 for calculation of the second focal position. The focus lens 112 may be moved according to the first focal position to perform a coarse focusing operation for the input image. Then, as the position of the focus lens 112 is adjusted through the operation of the second focal position calculator 620, a fine focusing operation for the input image may be performed.

FIG. 10 is a diagram for explaining the functions of the first focal position calculator, and FIG. 11 illustrates the focal position table.

Referring to FIG. 10, the first focal position calculator 610 may calculate a first focal position based on the distance to a subject, zoom level, and installation environment.

The first focal position calculator 610 may calculate a first focal position based on the focal position table 800, which includes correlations among the distance to the subject, zoom level, the installation environment of the camera 100, and the focal position of the focus lens 112. Referring to FIG. 11, the focal position table 800 may include a subject distance field 810, a zoom level field 820, a temperature field 830, an acceleration field 840, and a focal position field 850.

The subject distance field 810 may indicate the distance to the subject. The zoom level field 820 may indicate the zoom level of the lens portion 110. The temperature field 830 may indicate the ambient temperature of the location where the camera 100 is installed. The acceleration field 840 may indicate the gravitational acceleration acting on the camera 100. The focal position field 850 may indicate the focal position of the focus lens 112. Focal positions corresponding to various combinations of subject distance, zoom level, temperature, and acceleration may be indicated in the focal position table 800.

The first focal position calculator 610 may apply the subject distance determined by the distance determiner 200, the zoom level input by the user, and the temperature and acceleration determined by the environment determiner 300 to the focal position table 800 and extract the corresponding focal position as a first focal position.

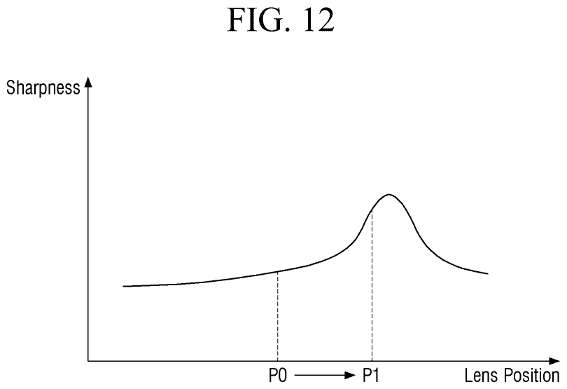

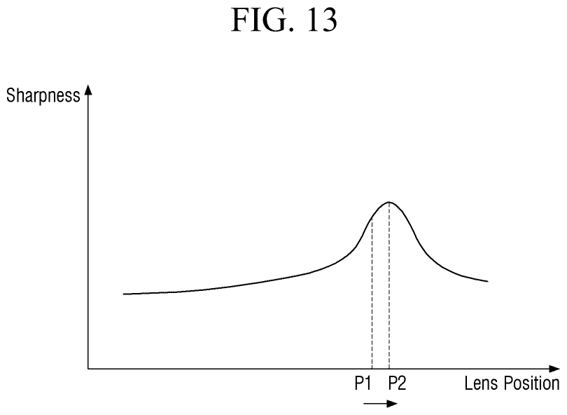

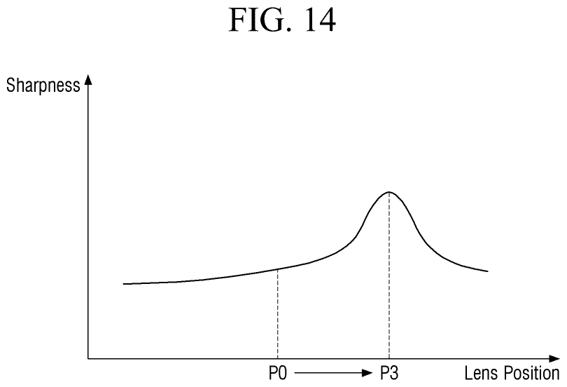

FIG. 12 is a diagram for explaining adjustment of the position of the focus lens according to a first focal position, FIG. 13 is a diagram for explaining adjustment of the position of the focus lens according to a second focal position, and FIG. 14 is a diagram for explaining adjustment of the position of the focus lens according to an updated first focal position.

Referring to FIG. 12, the position of the focus lens 112 may be adjusted according to a first focal position.

FIG. 12 illustrates a graph showing the sharpness of an image according to the position of the focus lens 112. When the first focal position calculator 610 calculates P1 as a first focal position when the focus lens 112 is at P0, the controller 500 may move the focus lens 112 from P0 to P1. As the focus lens 112 moves, the sharpness of the image may increase.

The focal position table 800 may be generated at the time of manufacture of the apparatus 10. For example, the focal position table 800 may be generated with reference to the image capturing performance of the apparatus 10, and different focal position tables 800 may be generated for different apparatuses 10 for capturing an image.

As the apparatus 10 is operated over a long period of time, performance changes may occur, and in such cases, errors may be reflected in the values indicated in the focal position table 800. As shown in FIG. 12, while the focus lens 112 is moved to the first focal position, the image sharpness may not reach the maximum level. Accordingly, the apparatus 10 according to an embodiment of the disclosure may calculate an optimal focal position, which is a second focal position, by finely or precisely adjusting the position of the focus lens 112 after the focus lens 112 is moved to the first focal position.

Referring to FIG. 13, the position of the focus lens 112 may be adjusted according to a second focal position.

The second focal position calculator 620 may calculate P2 as the second focal position while continuously adjusting the position of the focus lens 112. As a result of the operation of the second focal position calculator 620, the focus lens 112 may move from P1 to P2, and the image may attain optimal sharpness.

The controller 500 may update the focal position of the focus lens 112 included in the focal position table 800 based on the difference between the first and second focal positions. When the focal position is updated, the first focal position calculator 610 may extract the updated first focal position later using the same subject distance, zoom level, temperature, and acceleration. Referring to FIG. 14, the focus lens 112 may be directly moved from P0 to P3. Here, P3 may be an updated first focal position and may be a focal position that provides optimal sharpness.

Since the focal positions included in the focal position table 800 are continuously updated, faster focus adjustment may become possible.

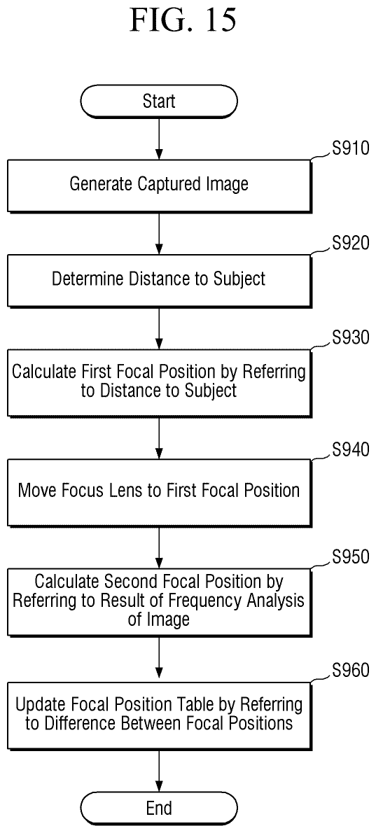

FIG. 15 is a flowchart illustrating a method for capturing an image according to an embodiment of the disclosure.

Referring to FIG. 15, the camera 100 of the apparatus 10 may capture and generate an image of a subject (S910).

After the image is generated, the distance determiner 200 may determine the distance to the subject (S920). Meanwhile, according to some embodiments of the disclosure, the distance to the subject may be determined by the distance determiner 200 before the image is generated by the camera 100, or the generation of the image by the camera 100 and the determination of the distance to the subject by the distance determiner 200 may be performed simultaneously.

After the determination of the distance to the subject, the first focal position calculator 610 may calculate a first focal position based on the determined subject distance (S930). At this time, the first focal position calculator 610 may determine whether a user-set focal position or a scan-based focal position is stored in the storage 400. When the user-set focal position, the scan-based focal position, or both are stored in the storage 400, the first focal position calculator 610 may calculate a first focal position having the highest priority based on a focal position stored in the storage 400.

When a distance-based focal position is calculated as the first focal position, the first focal position calculator 610 may calculate the first focal position by applying not only the distance to the subject but also the zoom level of the lens portion 110 and the installation environment of the camera 100 to the focal position table 800.

Once the first focal position may be calculated, the controller 500 may move the focus lens 112 to the first focal position (S940). As the focus lens 112 moves, the sharpness of the image may be improved.

After the focus lens 112 is moved to the first focal position, the second focal position calculator 620 may analyze the frequency of the image generated according to the adjustment of the position of the focus lens 112, thereby calculating the second focal position of the focus lens 112 (S950). For example, the second focal position calculator 620 may finely adjust the focus lens 112 and calculate the second focal position that provides optimal sharpness. As the calculation of the second focal position proceeds, the focus lens 112 may be moved to the second focal position, and the image may attain optimal sharpness.

After the calculation of the second focal position, the controller 500 may update the focal position table 800 based on the difference between the first and second focal positions (S960). An updated focal position may be indicated in the focal position table 800, and the first focal position calculator 610 may then be able to calculate the updated focal position as the first focal position.

At least one of the components, elements, modules or units (collectively “components” in this paragraph) represented by a block or an equivalent indication in the drawings including FIGS. 1 and 9 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in a storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

While embodiments of the disclosure are described above with reference to the accompanying drawings, it will be understood by those skilled in the art that the disclosure may be implemented in various specific forms without changing the technical spirit or essential characteristics. Therefore, the above-described embodiments are to be understood as illustrative in all aspects and not as limiting.

What is claimed is:

1. An apparatus comprising:
a camera comprising a first lens and configured to generate an image of a subject;
a distance determiner configured to determine a distance to the subject;
a first focal position calculator configured to calculate a first focal position of the first lens based on the distance to the subject;
a second focal position calculator configured to calculate a second focal position of the first lens by analyzing a frequency of an image generated according to adjustment of a position of the first lens; and
a controller configured to adjust the position of the first lens based on the first and second focal positions.

2. The apparatus of claim 1, wherein the first focal position calculator is configured to calculate the first focal position based on a focal position table comprising correlations among the distance to the subject, a zoom level, an installation environment of the camera, and a focal position of the first lens.

3. The apparatus of claim 2, wherein the controller is configured to update the focal position of the first lens in the focal position table based on a difference between the first and second focal positions.

4. The apparatus of claim 2, wherein the installation environment of the camera comprises an ambient temperature of the camera and an installation posture of the camera.

5. The apparatus of claim 1, wherein the controller is configured to adjust the position of the first lens according to the first focal position and then adjust the position of the first lens to calculate the second focal position.

6. An apparatus comprising:
a camera comprising a first lens and a second lens and configured to generate an image of a subject;
an input interface configured to receive a target point selection command for selecting a target point in the image;
a first focal position calculator configured to calculate a first focal position of the first lens to improve sharpness of an image of a subject region formed based on the target point; and
a controller configured to control the second lens such that the subject region is enlarged at a selected zoom level and to adjust a position of the first lens according to the first focal position,
wherein the first focal position calculator is configured to calculate the first focal position having a highest priority from among a plurality of first focal positions calculable for the subject region.

7. The apparatus of claim 6, wherein the plurality of first focal positions calculable for the subject region comprise:
a user-set focal position set by a user for the subject region;
a distance-based focal position calculated based on a distance to a subject in the subject region; and
a scan-based focal position set through scanning of the subject region.

8. The apparatus of claim 7, wherein priorities of the plurality of first focal positions are set in an order of the user-set focal position, the distance-based focal position, and the scan-based focal position.

9. The apparatus of claim 6, further comprising:
a second focal position calculator configured to calculate a second focal position of the first lens by analyzing a frequency of an image generated according to adjustment of the position of the first lens.

10. An apparatus comprising:
a camera comprising a first lens and a second lens and configured to generate an image of a subject;
an input interface configured to receive a region setting command for setting a target region in the image;
a first focal position calculator configured to calculate a first focal position of the first lens to improve sharpness of an image of the target region; and
a controller configured to control the second lens such that the target region is enlarged and to adjust a position of the first lens according to the first focal position,
wherein the first focal position calculator is configured to calculate the first focal position having a highest priority from among a plurality of first focal positions calculable for the target region.

11. The apparatus of claim 10, wherein the plurality of first focal positions calculable for the target region comprise:
a user-set focal position set by a user for the target region;
a distance-based focal position calculated based on a distance to a subject in the target region; and
a scan-based focal position set through scanning of the target region.

12. The apparatus of claim 11, wherein priorities of the plurality of first focal positions are set in an order of the user-set focal position, the distance-based focal position, and the scan-based focal position.

13. The apparatus of claim 10, further comprising:
a second focal position calculator configured to calculate a second focal position of the first lens by analyzing a frequency of an image generated according to adjustment of the position of the first lens.

14. A method for capturing an image, the method comprising:
generating an image of a subject;
determining a distance to the subject;
calculating a first focal position of a first lens based on the distance to the subject;
adjusting a position of the first lens according to the first focal position;
calculating a second focal position of the first lens by analyzing an image generated according to adjustment of the position of the first lens; and
adjusting the position of the first lens according to the second focal position.

15. The method of claim 14, wherein the calculating of the first focal position comprises calculating the first focal position based on a focal position table comprising correlations among the distance to the subject, a zoom level, an installation environment of a camera, and a focal position of the first lens.

16. The method of claim 15, further comprising:
updating the focal position of the first lens in the focal position table based on a difference between the first and second focal positions.

17. A method for capturing an image, the method comprising:
generating an image of a subject;
receiving a target point selection command for selecting a target point in the image;
controlling a second lens such that a subject region formed based on the target point is enlarged at a selected zoom level;
calculating a first focal position of a first lens to improve sharpness of the subject region; and
adjusting a position of the first lens according to the first focal position,
wherein the calculating of the first focal position comprises calculating the first focal position having a highest priority from among a plurality of first focal positions calculable for the subject region.

18. The method of claim 17, wherein:
the plurality of first focal positions calculable for the subject region comprise: a user-set focal position set by a user for the subject region; a distance-based focal position calculated based on a distance to a subject in the subject region; and a scan-based focal position set through scanning of the subject region, and
priorities of the plurality of first focal positions are set in an order of the user-set focal position, the distance-based focal position, and the scan-based focal position.

19. A method for capturing an image, the method comprising:
generating an image of a subject;
receiving a region setting command for setting a target region in the image;
controlling a second lens such that the target region is enlarged to a size of a screen region;
calculating a first focal position of a first lens to improve sharpness of the image of the target region; and
adjusting a position of the first lens according to the first focal position,
wherein the calculating of the first focal position comprises calculating the first focal position having a highest priority from among a plurality of first focal positions calculable for the target region.

20. The method of claim 19, wherein:
the plurality of first focal positions calculable for the target region comprise: a user-set focal position set by a user for the target region; a distance-based focal position calculated based on a distance to a subject in the target region; and a scan-based focal position set through scanning of the target region, and
priorities of the plurality of first focal positions are set in an order of the user-set focal position, the distance-based focal position, and the scan-based focal position.
